(19) United States
(12) Patent Application Publication
(10) Pub. No.: US 2026/0297445 A1
(43) Pub. Date: Oct. 1, 2026

(54) GENERATION AND UTILIZATION OF AMMONIATED WATER IN GASIFICATION

(71) Applicant: SunGas Renewables, Inc., Houston, TX (US)

(72) Inventor: Terry HUGHES, Jersey Village, TX (US)

(21) Appl. No.: 19/478,301

(22) PCT Filed: Apr. 25, 2024
(86) PCT No.: PCT/US2024/026166

§ 371 Date: Oct. 24, 2025

Related U.S. Application Data
(60) Provisional application No. 63/461,951, filed on Apr. 26, 2023.

(51) Int. Cl. C10K 1/10; B01D 46/00; B01D 53/14; C10J 3/84; C10K 1/00; C10K 1/02; C10K 3/04

(52) U.S. Cl. CPC C10K 1/101; B01D 46/0036; B01D 53/1406; B01D 53/1431; C10J 3/845; C10K 1/002; C10K 1/024; C10K 3/04; B01D 2252/103; B01D 2256/16; B01D 2256/20; B01D 2257/406; C10J 2300/092; C10J 2300/0959; C10J 2300/1618

(57) ABSTRACT

Gasification processes utilizing carbonaceous feeds and preferably biomass are disclosed, which can implement one or more strategies for generating an ammoniated water product having, in addition to alkalinity, suitable purity for utilization in a number of applications, including those within the overall process. Exemplary applications involve neutralization of sump and interfacing slag water systems. Recovery by condensation of this ammoniated water product from an overhead vapor product of a first scrubber contacting stage may be performed in conjunction with a scrubbing operation that utilizes a scrubber vessel containing this scrubber contacting stage and optionally one, two, or more additional scrubber contacting stages, for example separated vertically by individual aqueous scrubber feeds that are input at varying axial heights.

### CROSS REFERENCE TO RELATED APPLICATION

This application claims the benefit of priority to U.S. Provisional Application No. 63/461,951, filed Apr. 26, 2023, which is hereby incorporated by reference in its entirety

### FIELD OF THE INVENTION

Aspects of the invention relate to gasification processes, and more particularly the recovery of an ammoniated water product in such processes, for example from a scrubbing operation used to remove water-soluble contaminants from a gasifier effluent.

### DESCRIPTION OF RELATED ART

The gasification of coal has been performed industrially for over a century in the production of synthesis gas (syngas) that can be further processed into transportation fuels and other valuable end products. More recent efforts toward developing energy independence with reduced greenhouse gas emissions have led to a strong interest in using biomass as a gasification feed, and thereby an alternative potential source of synthesis gas, as well as its downstream conversion products. Generally, biomass gasification is performed by partial oxidation in the presence of a suitable oxidizing gas containing oxygen and other possible components such as steam. Gasification at elevated temperature and pressure, optionally in the presence of a catalytic material, produces an effluent with hydrogen and oxides of carbon (CO, CO₂), as well as hydrocarbons such as methane. This effluent, which is often referred to as synthesis gas in view of its H₂ and CO content, must be cooled significantly and also treated to remove a number of undesired components that can include particulates, alkali metals, halides, and sulfur compounds, in addition to byproducts of gasification that are generally referred to as tars and oils. Furthermore, downstream conversion of the synthesis gas to value-added products often requires its hydrogen content to be increased, relative to that obtained from gasification alone.

Undesired tar components in the gasifier effluent, which can include fused ring molecules such as naphthalene and pyrene, pose significant challenges in terms of the tendency of such high boiling-temperature molecules to condense from the vapor phase onto lower-temperature surfaces encountered downstream of the gasifier. Physical deposition of tars and oils is known to cause fouling/clogging of process lines, valves, reactors, and other equipment. For these reasons, the thermal destruction of tar is commonly practiced, but this, in turn, requires temperatures of about 1300° C., well exceeding those of the gasifier and sufficient to cause melting and/or slagging of ash that is also present in tar-laden syngas stream or gasifier effluent. The molten material or slag is itself a source of potential fouling and plugging, due to deposition at cooler downstream temperatures, such as encountered in equipment for upgrading of synthesis gas to end products. To mitigate these problems, the use of a sufficiently large-sized radiant syngas cooler (RSC) is viewed as a possible way to separate slag via a quench chamber at the bottom of this apparatus.

Regarding the need to increase the H₂:CO molar ratio of the synthesis gas for its subsequent use in a number of reactions, the exothermic water-gas shift (WGS) reaction gas according to:

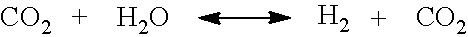

is widely exploited. The thermodynamics of this reaction govern an equilibrium shift toward hydrogen production at lower temperatures, which are generally unfavorable from the standpoint of reaction kinetics. Operations conducted to purify the gasifier effluent, or synthesis gas, in preparation for the catalytic WGS reaction, include scrubbing to remove water-soluble contaminants. The scrubbing operation, however, generally requires a reduction in both temperature and moisture content of the resulting scrubbed gasifier effluent, thereby directionally reducing its suitability in these respects for the WGS operation. Overall, the economics of biomass gasification and the effective utilization of the produced synthesis gas for obtaining desired end products are impacted by a number of complex and interacting processing objectives, as well as the associated equipment requirements. The present state of the art would benefit from improvements in gasification technology, relating to the generation of valuable intermediate products, and particularly those that can be utilized within the process to render it more financially attractive.

### SUMMARY OF THE INVENTION

Aspects of the invention are associated with the discovery of gasification processes utilizing carbonaceous feeds and preferably biomass, which can implement one or more strategies for recovering an ammoniated water product, and particularly such product having suitable qualities in terms of reduced levels of contaminants (e.g., chlorides, solid particles) for its utilization within the process. The ammoniated water product may be condensed from syngas produced by gasification of carbonaceous feed, following at least a single scrubbing stage (e.g., following contact in a first stage scrubber with a first stage aqueous scrubber feed). For example, this product may be condensed at a temperature of the syngas that is at or below its saturation temperature, such as in a cooled, second stage scrubber. In some embodiments, this single scrubbing stage, i.e., first scrubber contacting stage or first stage scrubber, may be used to remove chloride present in the scrubber feed. The ammoniated water product may comprise ammonia derived from nitrogen present in the carbonaceous feed (e.g., biomass such as wood). Advantageously, such ammoniated water product (e.g., an aqueous ammonia or ammonium hydroxide solution having a pH of at least about 7.5) can provide a source of basic solution that can satisfy process requirements associated with neutralization and/or solids handling, particularly for applications in which chloride contamination might be problematic. Such applications include cooler sumps and slag water systems.

Embodiments of the invention are directed to gasification processes and associated configurations that allow a process condensate comprising ammonia that is relatively “clean” (i.e., relatively free of other contaminants) to be recycled to operations upstream of where this condensate is generated, thereby offsetting makeup water requirements (e.g., external to the process). Accordingly, the ammoniated and recycled aqueous product can reduce costly high-quality makeup water requirements for these upstream operations, such as a radiant syngas cooler (RSC) or a convective syngas cooler (CSC) and more particularly their associated sumps and/or slag water systems. Ammonia present in this recycled aqueous product can promote pH control of these systems by neutralizing/reducing acidic chlorides (e.g., HCl) and/or other acidic species that may likewise concentrate in such systems. In this regard, slag water systems or other process water systems used in gasification processes can operate with elevated chloride levels, stemming from the tendency for chloride, originally present in the carbonaceous feed (in addition to nitrogen that is ultimately a source of the recovered ammonia), to form HCl under conditions of gasification/tar removal and to accumulate in the process lines and equipment of these systems.

Particular aspects of the invention therefore relate to overcoming metallurgical requirements (i.e., the use of upgraded metal compositions) in these systems, as needed conventionally to attain a high level of corrosion resistance. For example, slag water systems or other process water systems operating at elevated levels of chloride (e.g., HCl) can often require duplex or other stainless steels to avoid corrosion/equipment failure and/or the need to inject costly corrosion inhibitors. Other particular aspects relate to mitigating or eliminating the need for expensive, high-quality (e.g., oxygen-free) makeup water for use in sumps and so-called “dirty” water systems of the process, including slag water systems and RSC sumps. A typical source of such makeup water is boiler feed water, which becomes contaminated once added to the process though makeup valving. Following contamination, this previously high-quality water is eventually discarded through wastewater, thereby resulting in significant expenses over the course of extended, continuous operation of the process. Such demand for high-quality makeup water to sustain the process can become very costly year over year.

In view of these considerations, integration between process streams and systems, according to processes described herein, can advantageously utilize available products with the potential to alleviate both capital and operating costs. One such product is an ammoniated water product that may be recovered from a scrubbing operation, typically used for the removal of water-soluble contaminants from the gasifier effluent. More particularly, this product may result from subjecting the gasifier effluent to at least a first scrubber contacting stage, for example to remove all or substantially all chlorides present in this stream, optionally in conjunction with other water-soluble contaminants that are more easily removable compared to ammonia, under conditions in this first scrubber contacting stage. The ammoniated water product may be condensed from the “clean” syngas obtained, following the first scrubber contacting stage, either in a second scrubber contacting stage or higher scrubber contacting stage (e.g., within the same vessel used to perform the first scrubber contacting stage) or in a condenser external to the first scrubber contacting stage or higher scrubber contacting stage. In either embodiment, the option exists to add a portion of the ammoniated water back to first scrubber contacting stage, or back to a vessel that performs both the first scrubber contacting stage and a second scrubber contacting stage or higher scrubber contacting stage (e.g., by adding it to a first stage aqueous scrubber feed or recycle loop comprising this feed). Importantly, the option in either embodiment also exists to add at least a portion of the ammoniated water to process streams and/or associated equipment that would otherwise involve exposure to acidic conditions (e.g., resulting from significant levels of acidic chlorides), for example to a sump or slag water system of an RSC. The second scrubber contacting stage or higher scrubber contacting stage, relative to the first scrubber contacting stage, may be considered a “cooled” contacting stage, in which contacting is performed at a lower temperature.

Advantages of processes described herein reside in the ability to effectively utilize ammoniated water, as an alternative to its discharge into wastewater systems. This utilization may involve chloride/HCl neutralization and/or pH control for the benefit of various systems, such as to prevent or minimize higher cost metallurgical upgrades. Recycling of an ammoniated water product can offset or reduce the quantity of clean water makeup (e.g., from external sources) required in sumps and slag water systems (e.g., of an RSC or other syngas cooler). This product can also beneficially serve as cooling water, aiding in the maintenance of these systems below a given threshold temperature, such the flash point when pressure is reduced to atmospheric.

Certain embodiments of the invention are directed to a process for gasification of a carbonaceous feed. The process comprises, in a gasifier, contacting the carbonaceous feed with an oxygen-containing gasifier feed, under gasification conditions, to provide an un-scrubbed gasifier effluent comprising H₂, CO, and water-soluble contaminants. Some particular embodiments may further comprise feeding at least a portion of the un-scrubbed gasifier effluent, as a scrubber feed, to a scrubbing operation to remove at least a portion of the water-soluble contaminants, and provide a scrubbed gasifier effluent. These particular embodiments may also comprise recovering from the scrubbing operation, following at least a first scrubber contacting stage, an ammoniated water product. Other particular embodiments may further comprise, optionally following one more intervening operations downstream of the gasifier, feeding at least a portion of the un-scrubbed gasifier effluent, as a scrubber feed, to a scrubbing operation to remove at least a portion of the water-soluble contaminants, and provide a scrubbed gasifier effluent. These other particular embodiments may also comprise recovering from the scrubbing operation, (e.g., following at least a first scrubber contacting stage) an ammoniated water product and a chloride-enriched aqueous product (e.g., a first stage purge that is enriched in chlorides, relative to the scrubber feed).

These and other embodiments, aspects, and advantages relating to the present invention are apparent from the following Detailed Description.

### BRIEF DESCRIPTION OF THE DRAWINGS

A more complete understanding of the exemplary embodiments of the present invention and the advantages thereof may be acquired by referring to the following description in consideration of the accompanying figures, in which the same reference numbers are used to identify the same features.

FIG. 1 depicts a flowscheme illustrating an embodiment of a process for the gasification of a carbonaceous feed, which process employs a number of possible features as described herein, including a scrubbing operation, from which an ammoniated water product is recovered.

FIGS. 2 and 3 depict flowschemes illustrating certain aspects of the scrubbing operation in more detail, such as flows of aqueous and gaseous streams about a first stage scrubber and a second scrubber of this operation (FIG. 2), or flows of aqueous and gaseous streams about a first stage scrubber in combination with a first stage overhead condenser of this operation (FIG. 3).

For the sake of simplicity, multiple features are illustrated and described in each of the figures, with the understanding that not all features (e.g., not all individual operations and their associated process streams and equipment) are required and that various specific features can be implemented independently of others.

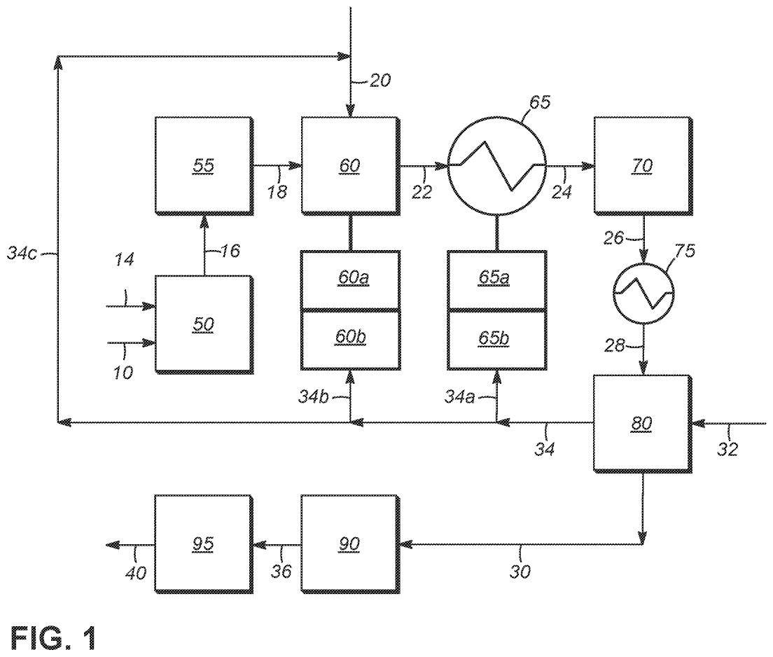

In order to facilitate explanation and understanding, FIGS. 1-3 provide an overview of these and other features for implementation in gasification processes. Some associated equipment such as certain vessels, heat exchangers, valves, instrumentation, and utilities, are not shown, as their specific description is not essential to the implementation or understanding of the various aspects of the invention. Such equipment would be readily apparent to those skilled in the art, having knowledge of the present disclosure. Other processes for producing syngas and/or its conversion products such as renewable liquids, according to other embodiments within the scope of the invention and having configurations and constituents determined, in part, according to particular processing objectives, would likewise be apparent.

### DETAILED DESCRIPTION

The expressions “wt-%” and “mol-%,” are used herein to designate weight percentages and molar percentages, respectively. The expressions “wt-ppm” and “mol-ppm” designate weight and molar parts per million, respectively. For ideal gases, “mol-%” and “mol-ppm” are equal to percentages by volume and parts per million by volume, respectively. The terms “barg” and “psig,” when used herein, designate gauge pressures (i.e., pressure in excess of atmospheric pressure) in units of bars and pounds per square inch, respectively, whereas the terms “bar” and “psi,” when used herein, designate absolute pressures. For example, gauge pressures of 0 barg and 0 psig are approximately equivalent to absolute pressures of 1 bar and 14.5 psi, respectively.

The term “substantially,” as used herein, refers to an extent of at least 95%. For example, the phrase “substantially all” may be replaced by “at least 95%.” The phrases “all or a portion” or “at least a portion” are meant to encompass, in certain embodiments, “at least 50% of,” “at least 75% of,” “at least 90% of,” and, in preferred embodiments, “all.” Likewise, designated portions, such as a “first portion” or “second portion” may represent these percentages (but not all) of the total, and particularly these percentages (but not all) of the total process stream to which they refer.

Reference to any starting material, intermediate product, or final product, which are all preferably process streams in the case of continuous processes, should be understood to mean “all or a portion” of such starting material, intermediate product, or final product, in view of the possibility that some portions may not be used, such as due to sampling, purging, diversion for other purposes, mechanical losses, etc. Therefore, for example, the phrase “feeding . . . , as a scrubber feed, to a scrubbing operation” should be understood to mean feeding all or a portion of the scrubber feed to the scrubbing operation. As in the case of “all or portion” being expressly stated, when “all or a portion” is the understood meaning, this phrase is should further be understood to encompasses certain and preferred embodiments as noted above.

Representative processes described herein for the gasification of a carbonaceous feed may comprise a number of unit operations, with one of such operations stated as being performed or carried out “before,” “prior to,” or “upstream of” another of such operations, or with one of such operations being performed or carried out “after,” “subsequent to,” or “downstream of,” another of such operations. These quoted phrases, which refer to the order in which one operation is performed or carried out relative to another, are in reference to the overall process flow, as would be appreciated by one skilled in the art having knowledge of the present specification. More specifically, the overall process flow can be defined by the bulk gasifier effluent flow, including bulk flows of both the un-scrubbed gasifier effluent and scrubbed gasifier effluent, as well as the bulk WGS product flow, as such flow(s) is/are subjected to operations as defined herein. Insofar as the quoted phrases are used to designate order, in specific embodiments these phrases mean that one operation immediately precedes or follows another operation, whereas more generally these phrases do not preclude the possibility of intervening operations. Therefore, for example, one or more “operations downstream of the gasifier” can refer, according to a specific embodiment, an operation that immediately follows the gasifier, such as in the case of a tar removal operation according to the embodiment illustrated in FIG. 1. However, this phrase more generally, and preferably, refers to any of, or any combination of, operations that follow the gasifier, whether or not intervening operations are present, such as in the case of any one or more of a quenching operation, a radiant syngas cooler (RSC) or convective syngas cooler (CSC), and/or a filtration operation that follow the tar removal operation, as an intervening operation, according to the embodiment illustrated in FIG. 1. Therefore, to the extent that representative processes described herein are defined as including certain unit operations, unless otherwise stated or designated (e.g., by using the phrase “consisting of”), such processes do not preclude the use of other operations, whether or not specifically described herein.

Specific processes described herein are defined by a gasifier, a scrubbing operation (e.g., wet scrubber) downstream of the gasifier, and a WGS operation downstream of the scrubbing operation. The gasifier provides a “gasifier effluent” and the WGS operation provides a “WGS product.” The term “gasifier effluent” is a general term that refers to the effluent of the gasifier, whether or not having been subjected to one or more operations downstream of the gasifier and upstream of the WGS operation. The “gasifier effluent” may be more particularly designated as an “un-scrubbed gasifier effluent” or a “scrubbed gasifier effluent,” which are also general terms but add specificity in terms of characterizing the gasifier effluent depending on whether or not it has been subjected to the scrubbing operation.

The terms “gasifier effluent” and “un-scrubbed gasifier effluent” encompass more specific terms that designate (i) the effluent provided directly by the gasifier, i.e., the “raw gasifier effluent,” (ii) the raw gasifier effluent having been subjected to at least a tar removal operation, i.e., a “tar-depleted gasifier effluent,” having a lower concentration of tars and oils relative to the raw gasifier effluent, (iii) the raw gasifier effluent having been subjected to at least a dry quenching operation, i.e., a “quenched gasifier effluent,” having a lower temperature and higher moisture (H₂O) concentration relative to the raw gasifier effluent, resulting from direct quenching (e.g., partial quenching) with water, (iv) the raw gasifier effluent having been subjected to at least a radiant syngas cooler (RSC) or at least a convective syngas cooler (CSC), i.e., a “cooled gasifier effluent” having a lower temperature relative to the raw gasifier effluent, resulting from heat transfer for external steam generation, (v) the raw gasifier effluent having been subjected to at least a filtration operation, i.e., a “filtered gasifier effluent,” having a lower solid particle content relative to the raw gasifier effluent, and which may provide all or part of a “heated scrubber feed,” or otherwise all or part of a “scrubber feed,” (vi) the raw gasifier effluent having been subjected to removal of heat, and which may provide all or a part of a “scrubber feed,” having a lower temperature relative to the raw gasifier effluent, resulting from heat removal (e.g., to generate steam), and (vii) the raw gasifier effluent having been subjected to any other operation upstream of the scrubbing operation, whether or not specifically described herein.

Likewise, the terms “gasifier effluent” and “scrubbed gasifier effluent” encompass more specific terms that designate (viii) the raw gasifier effluent or un-scrubbed gasifier effluent having been subjected to a scrubbing operation to reduce its content of water-soluble contaminants (e.g., chlorides), and (ix) the raw gasifier effluent or scrubbed gasifier effluent having been subjected to any other operation downstream of the scrubbing operation, whether or not specifically described herein. The terms “gasifier effluent,” “un-scrubbed gasifier effluent,” and “scrubbed gasifier effluent,” and any of the more specific examples (i)-(ix) of these terms, encompass products (e.g., flow streams) that are upstream of, and optionally may be fed to, the WGS operation.

The term “WGS product” is a general term that refers to a product of the WGS operation, all or a portion of which may, according to particular embodiments, be fed to a syngas conversion operation or a syngas separation operation to provide as a value-added product, a renewable syngas conversion product or a renewable syngas separation product. The term “WGS product” encompasses all or a portion of the product provided directly by the WGS operation, or otherwise such product after having been subjected to heating, cooling, pressurization, depressurization, and/or purification, such as acid gas removal. The terms “syngas,” or alternatively “synthesis gas product,” insofar as they relate to streams comprising H₂ and CO, are used herein to generally refer to the gasifier effluent, whether an un-scrubbed gasifier effluent or a scrubbed gasifier effluent as defined above, or the WGS product.

Particular examples of renewable syngas conversion products and renewable syngas separation products include both renewable liquid products (e.g., liquid hydrocarbons or methanol) and renewable gaseous products (e.g., renewable natural gas (RNG) or renewable hydrogen). The modifiers “syngas conversion” and “syngas separation,” as well as the modifiers “conversion” and “separation,” as used in the terms “renewable syngas conversion product,” “renewable syngas separation product,” “gaseous conversion byproduct,” “liquid conversion byproduct,” and “gaseous separation byproduct” are meant to more specifically designate the origin of these products and byproducts, as being obtained from either a syngas conversion operation (e.g., comprising a Fischer-Tropsch reaction stage, a methanol synthesis reaction stage, or a methanation reaction stage) or a syngas separation operation (e.g., comprising a hydrogen purification stage, such as in the case of syngas separation by pressure swing adsorption (PSA) and/or the use of a membrane). Any such syngas conversion operation or syngas separation operation is preferably performed on the WGS product that can yield an increased, and more favorable, H₂:CO molar ratio, in terms of efficiently performing the desired conversion or separation. The use of the modifiers “separation” and “conversion” in the terms noted above to modify products and byproducts does not preclude such products and byproducts being obtained from a combination of separation and conversion.

Representative gasification processes described herein are defined by various possible operations, occurring downstream of the gasifier which may include a tar removal operation; operations for cooling, such as a quenching operation, an RSC and/or a CSC; a filtration operation; a scrubber feed cooler, such as by using a boiler; a scrubbing operation; a WGS operation; and a syngas conversion operation. Certain possible features of the gasifier, as well as these downstream operations and their associated process streams and conditions, according to preferred embodiments and otherwise any embodiments as defined in the claims, as well as the embodiment illustrated in FIGS. 1-3, are provided in the following description.

### Gasifier

Representative processes comprise, in a gasifier, contacting a carbonaceous feed with an oxygen-containing gasifier feed, under gasification conditions, to provide a gasifier effluent (e.g., a raw gasifier effluent) comprising synthesis gas.

The carbonaceous feed may comprise coal (e.g., high quality anthracite or bituminous coal, or lesser quality subbituminous, lignite, or peat), petroleum coke, asphaltene, and/or liquid petroleum residue, or other fossil-derived substance. In a preferred embodiment, the carbonaceous feed may comprise biomass. The term “biomass” refers to renewable (non-fossil-derived) substances derived from organisms living above the earth's surface or within the earth's oceans, rivers, and/or lakes. Representative biomass can include any plant material, or mixture of plant materials, such as a hardwood (e.g., whitewood), a softwood, a hardwood or softwood bark, lignin, algae, and/or lemna (sea weeds). Energy crops, or otherwise agricultural residues (e.g., logging residues) or other types of plant wastes or plant-derived wastes, may also be used as plant materials. Specific exemplary plant materials include corn fiber, corn stover, and sugar cane bagasse, in addition to “on-purpose” energy crops such as switchgrass, miscanthus, and algae. Short rotation forestry products, such as energy crops, include alder, ash, southern beech, birch, eucalyptus, poplar, willow, paper mulberry, Australian Blackwood, sycamore, and varieties of paulownia elongate. Other examples of suitable biomass include vegetable oils, carbohydrates (e.g., sugars), organic waste materials, such as waste paper, construction, demolition wastes, digester sludge, and biosludge. Representative carbonaceous feeds therefore include, or comprise, any of these types of biomass. Particular carbonaceous feeds comprising biomass include municipal solid waste (MSW) or products derived from MSW, such as refuse derived fuel (RDF). Carbonaceous feeds may comprise a combination of fossil-derived and renewable substances, including those described above. A preferred carbonaceous feed is wood (e.g., in the form of wood chips).

In the gasifier (or, more particularly, a gasification reactor of this gasifier), the carbonaceous feed is subjected to partial oxidation in the presence of an oxygen-containing gasifier feed, added in an amount generally limited to supply only 20-70% of the oxygen that would be necessary for complete combustion. The oxygen-containing gasifier feed will generally comprise other oxygenated gaseous components including H₂O and/or CO₂ that may likewise serve as oxidants of the carbonaceous feed. The oxygen-containing gasifier feed can refer to all gases being fed or added to the gasifier, or otherwise can refer to gas that is separate from other gases being fed or added, whether subsequently combined upstream of, or within, the gasifier. For example, the oxygen-containing gasifier feed may be introduced to the gasifier, along with steam, or a portion of steam, generated elsewhere in the process (e.g., RCS-generated steam or CSC-generated steam) and used as a separate feed. Contacting of the carbonaceous feed with the oxygen-containing gasifier feed in the gasifier provides a gasifier effluent, and more particularly a raw gasifier effluent as the product directly exiting the gasifier. One or more reactors (e.g., in series or parallel) of the gasifier may operate under gasification conditions present in such reactor(s), with these conditions including a temperature of generally from about 500° C. (932° F.) to about 1000° C. (1832° F.), and typically from about 816° C. (1500° F.) to about 1038° C. (1900° F.). Other gasification conditions may include atmospheric pressure or elevated pressure, for example an absolute pressure generally from about 0.1 megapascals (MPa) (14.5 psi) to about 10 MPa (1450 psi), and typically from about 1 MPa (145 psi) to about 3 MPa (435 psi), or from about 0.5 MPa (72 psi) to about 2 MPa (290 psi).

Gasification reactor configurations include counter-current fixed bed (“up draft”), co-current fixed bed (“down draft”), and entrained flow plasma. Different solid catalysts, having differing activities for one or more desired functions in gasification, such as tar reduction, enhanced H₂ yield, and/or reduced CO₂ yield, may be used. Limestone may be added to a gasification reactor, for example, to promote tar reduction by cracking. Various catalytic materials may be used in a gasification reactor, including solid particles of dolomite, supported nickel, alkali metals, and alkali metal compounds such as alkali metal carbonates, bicarbonates, and hydroxides. Often, a gasifier is operated with a gasification reactor having a fluidized bed of particles of the carbonaceous feed (and optionally particles of solid catalyst), with the oxygen-containing gasifier feed, and optionally separate, fluidizing H₂O- and/or CO₂-containing feeds, being fed upwardly through the particle bed. Exemplary types of fluidized beds include bubbling fluidized beds and entrained fluidized beds.

In addition to gasifier effluent tar, the raw gasifier effluent comprises CO, CO₂, and methane (CH₄) that are derived from the carbon present in the carbonaceous feed, as well as H₂ and/or H₂O, and generally both, together with other components in minor concentrations, as described below. According to the embodiment illustrated in FIG. 1, the raw gasifier effluent 16 may be obtained directly from gasifier 50, prior to further operations as described herein.

The raw gasifier effluent, or any gasifier effluent having been subjected to one or more operations as described herein, may comprise synthesis gas, i.e., may comprise both H₂ and CO, with these components being present in various amounts (concentrations), and preferably in a combined amount of greater than about 25 mol-% (e.g., from about 25 mol-% to about 95 mol-%), greater than about 50 mol-% (e.g., from about 50 mol-% to about 90 mol-%), or greater than about 65 mol-% (e.g., from about 65 mol-% to about 85 mol-%). With respect to any such combined amounts (concentrations), the H₂:CO molar ratio of the gasifier effluent may be suitable for use in downstream syngas conversion operations (reactions or separations), such as (i) the conversion to a renewable syngas conversion product comprising higher molecular weight hydrocarbons and/or alcohols of varying carbon numbers via Fischer-Tropsch conversion or (ii) the conversion to a renewable syngas conversion product comprising methanol via a catalytic methanol synthesis reaction, or (iii) the conversion to a renewable syngas conversion product comprising renewable natural gas (RNG) via catalytic methanation that increases the methane content in a resulting RNG stream, or (iv) the separation of a renewable syngas separation product comprising purified hydrogen. More typically, however, a WGS operation is needed to achieve a favorable H₂:CO molar ratio, and/or a favorable H₂ concentration, for these or other downstream syngas conversion and separation operations. For example, the WGS operation may include parameters (e.g., reactor temperatures and/or catalyst types) for obtaining the highest yield/concentration of hydrogen, through consumption of CO present in the syngas upstream of this operation, in the case obtaining purified hydrogen as a renewable syngas separation product (e.g., by utilizing one or more PSA and/or membrane separation stages).

Independently of, or in combination with, the representative amounts (concentrations) of H₂ and CO above, the gasifier effluent may comprise CO₂, for example in an amount of at least about 2 mol-% (e.g., from about 2 mol-% to about 30 mol-%), at least about 5 mol-% (e.g., from about 5 mol-% to about 25 mol-%), or at least about 10 mol-% (e.g., from about 10 mol-% to about 20 mol-%). Independently of, or in combination with, the representative amounts (concentrations) of H₂, CO, and CO₂ above, the gasifier effluent may comprise CH₄, for example in an amount of at least about 0.5 mol-% (e.g., from about 0.5 mol-% to about 15 mol-%), at least about 1 mol-% (e.g., from about 1 mol-% to about 10 mol-%), or at least about 2 mol-% (e.g., from about 2 mol-% to about 8 mol-%). Together with any water vapor (H₂O), these non-condensable gases H₂, CO, CO₂, and CH₄ may account for substantially all of the composition of the gasifier effluent. That is, these non-condensable gases and any water may be present in the gasifier effluent in a combined amount of at least about 90 mol-%, at least about 95 mol-%, or even at least about 99 mol-%.

### Tar Removal Operation

The raw gasifier effluent, obtained directly from the gasifier, will generally comprise gasifier effluent tar, such that a tar removal operation is typically necessary for further processing. This gasifier effluent tar can include compounds that are referred to in the art as “tars” and “oils” and are more particularly hydrocarbons and oxygenated hydrocarbons having molecular weights greater than that of methane, which may be present in the gasifier effluent at concentrations ranging from several wt-ppm to several wt-%. Certain types of these compounds, having relatively high molecular weight, are further characterized by being problematic due to their tendency to condense at lower temperatures and coat internal surfaces of processing equipment, downstream of the gasifier, causing undesirable fouling, corrosion, and/or plugging. These compounds also interfere with subsequent processing steps, or syngas conversion operations, for upgrading synthesis gas to higher value products, which perform optimally (e.g., from the standpoint of stability) with pure feed gases.

Particular compounds that are undesirable for these reasons include hydrocarbons and oxygenated hydrocarbons having six carbon atoms or more (C₆⁺ hydrocarbons and oxygenated hydrocarbons), with benzene, toluene, xylenes, naphthalene, pyrene, phenol, and cresols being specific examples. These compounds are typically present in the raw gasifier effluent in a total (combined) amount from 1-100 g/Nm³. The removal (e.g., by conversion) of these organic compounds is therefore generally necessary to avoid serious problems caused by their deposition over time. Other types of tars and oils, such as ethane, ethylene, and acetylene, will not condense from the gasifier effluent but will nonetheless “tie up” hydrogen and carbon, with the effect of reducing the overall yield of H₂ and CO as the desired components of synthesis gas.

Depending on the specific tar removal operation, tars and oils in the raw gasifier effluent can be converted, either catalytically or non-catalytically, by oxidation, cracking, and/or reforming to provide, in the tar-depleted gasifier effluent, additional H₂ and CO. The tar conversion reaction(s) can utilize available O₂ or oxygen sources (e.g., H₂O and/or CO₂) that are present in, and/or added to, the synthesis gas. In view of the gasifier effluent tar, together with methane, containing a significant portion of the energy of the raw gasifier effluent, the conversion of these compounds can increase the overall yield of synthesis gas substantially. The tar removal operation, which may therefore, according to certain embodiments, be more specifically a tar conversion operation, can effectively reduce the concentration of compounds present as tar in the raw gasifier effluent, having been produced in the gasifier. In general, tar removal, and more particularly tar conversion reactions, may be performed under higher temperatures compared to those used in the gasifier, such that the tar-depleted gasifier effluent, obtained directly from the tar removal operation, may have a temperature of greater than about 1000° C. (e.g., from about 1000° C. (1832° F.) to about 1500° C. (2732° F.), such as from about 1204° C. (2200° F.) to about 1427° C. (2600° F.)).

According to one embodiment, the tar removal operation may be used for the conversion (e.g., reforming) of tar and methane through non-catalytic partial oxidation (Pox) in a reactor used for this operation. The efficiency of this specific operation can be promoted using hot oxygen burner (HOB) technology, according to which an excess of oxygen is mixed with a small amount of fuel (e.g., natural gas, propane, or recycled synthesis gas). Combustion of this fuel within the reactor can result in a temperature increase to above 1100° C. (2012° F.), causing the combustion products and excess oxygen to accelerate to sonic velocity through a nozzle, thereby forming a turbulent jet that enhances mixing between the tar/methane containing synthesis gas and the reactive hot oxygen stream. An HOB-based system can effectively improve synthesis gas yields.

In the case of a tar removal operation that utilizes catalytic conversion of tar and methane, this operation may include a reactor containing a bed of catalyst comprising solid or supported Ni, solid or supported Fe, and/or dolomite, for example in the form of a secondary fluidized bed downstream of the gasifier. Other catalysts for tar conversion include olivine, limestone, zeolites, and even metal-containing char produced from the gasification. As in the case of non-catalytic processes that may be performed in a tar removal operation, catalytic tar conversion may likewise include the introduction of supplemental oxygen and/or steam reactants, into a reactor used for this operation.

According to other particular embodiments, the tar removal operation may utilize a suitable liquid or solid adsorbent, to selectively adsorb tars and oils from the raw gasifier effluent. For example, the tar removal operation may be performed with an oil washing system, whereby the raw gasifier effluent is passed through (contacted with) a liquid medium such as bio-oil liquor, to extract the tars and oils based on their preferential solubility. The liquid adsorbent may be combusted after it has become spent.

Regardless of the particular method by which the tar removal operation is performed, the raw gasifier effluent may comprise tars and oils (e.g., present as compounds described above) in an amount, or combined amount, from about 0.01 wt-% to about 5 wt-%, such as from about 0.1 wt-% to about 3 wt-% or from about 0.5 wt-% to about 2 wt-%. The tar removal operation may be effective to substantially or completely remove this gasifier effluent tar. For example, the tar-depleted gasifier effluent exiting, or obtained directly from, this operation, may comprise tars and oils in an amount, or combined amount, of less than about 0.5 wt-%, less than about 0.1 wt-%, or less than about 0.01 wt-%. Representative levels of removal of tars and oils (e.g., by conversion), measured across the tar removal operation, may be at least about 90%, at least about 95%, or even at least about 99%, resulting in a tar-depleted gasifier effluent that may be substantially or completely free of tar.

### Quenching Operation

Hot gasifier effluent, for example the tar-depleted gasifier effluent exiting the tar removal operation, can be cooled by various techniques that include radiant and/or convective heat exchange. In representative embodiments, at least one quenching operation, and preferably a dry quenching operation, may be used, in which water is added directly to the gasifier effluent and contributes to its overall moisture content, thereby favoring H₂ production via the equilibrium-limited WGS reaction (i.e., to provide an increased H₂:CO molar ratio and an increased H₂ concentration). A dry quenching operation utilizes the sensible heat of the gasifier effluent to vaporize the injected water, which is sufficient for obtaining the resulting quenched gasifier effluent at a desired, cooler temperature. In the case of using dry quenching without the further use of an RSC, the quenched gasifier effluent may have a temperature from about 400° C. (752° F.) to about 900° C. (1652° F.), and preferably from about 538° C. (1000° F.) to about 816° C. (1500° F.) to allow for further processing. Representative processes can include, after sufficient further cooling (e.g., using an RSC or a CSC) a subsequent filtration operation (passage through a filter) to remove solid particles (e.g., dust). In preferred embodiments, only a partial quench is used in the quenching operation, as opposed to a full quench, such that the quenched gasifier effluent exiting, or obtained directly from, the dry quenching operation is above its dewpoint, i.e., not saturated. In general, the dry quenching operation can promote rapid and efficient cooling through direct contact between hot gasifier effluent and water or other aqueous quenching medium.

### Radiant Syngas Cooler (RSC) or Convective Syngas Cooler (CSC)

As described herein, according to preferred embodiments, a combination of a quenching operation characterized by direct contact of a synthesis gas (e.g., the tar-depleted gasifier effluent exiting the tar removal operation) and a quenching medium such as water, together with an RSC or a CSC, can provide effective cooling for further downstream operations. Alternatively, or in combination, an RSC may be utilized for effective removal of ash and formed slag. For example, an RSC or a CSC may be used to cool a quenched gasifier effluent exiting the quenching operation to provide a cooled gasifier effluent, with the quenched gasifier effluent optionally having a temperature within a range as described above and/or the cooled gasifier effluent having temperature from about 250° C. (482° F.) to about 600° C. (1112° F.), and preferably from about 275° C. (527° F.) to about 350° C. (662° F.) to allow for subsequent filtration. An RSC or a CSC may operate by indirect heat transfer, such as in the case of having a shell and tube configuration, typically with the generation steam from some of the heat recovered from the gasifier and tar removal operation. According to more particular embodiments, an RSC or CSC may operate as a boiler (e.g., a fire tube boiler or water tube boiler) for the production of medium and/or high pressure steam.

### Filtration Operation

A filtration operation, using any suitable filter, may be used to remove solid particles (particulates) from the gasifier effluent, for example the cooled gasifier effluent as described above, exiting an RSC or a CSC. In the case of biomass gasification, these solid particles can include char, tar, soot, and ash, any of which can generally contain alkali metals such as sodium. Corrosive and/or harmful species such as chlorides, arsenic, and/or mercury may also be contained in such solid particles. A high temperature filtration, for example using bundles of metal or ceramic filters, may generally be sufficient to reduce the content of solid particles in the gasifier effluent, such as to provide a filtered gasifier effluent exiting, or obtained directly from, the filtration operation and having less than 1 wt-ppm, and possibly less than 0.1 wt-ppm of solid particles. In representative embodiments, the filtered gasifier effluent may have a temperature in a range as described above with respect to the cooled gasifier effluent.

In some embodiments, a filtration operation may be performed upstream of (prior to) the tar removal operation to allow the latter to operate more effectively. The removal of solid particles of varying average particles sizes, using filtration or other techniques, may be performed at any of a number of possible stages within the overall process. For example, coarse solids removal by centrifugation may be performed directly downstream of the gasifier, and/or may even be performed in situ in the gasifier (e.g., using internal cyclones, for removal of solid particles, positioned in a headspace above a fluidized particle bed).

The filtration operation may be followed by, or integrated with, a supplemental cleaning operation to further purify the gasifier effluent, such as to further reduce its tar and overall hydrocarbon content, for example by contact with a solid “polishing” material such as a carbon bed. This can provide for more thorough removal of benzene, naphthalene, pyrene, toluene, phenols, and other condensable species that could otherwise be detrimental to downstream operations, such as by deposition onto equipment.

### Scrubber Feed Cooler

Prior to the scrubbing operation, heat may be removed from the gasifier effluent, such as the filtered gasifier effluent described above and exiting, or obtained directly from, the filtration operation. According to some embodiments, a boiler and/or an air cooler (employing fans) may be used as a scrubber feed cooler to carry out indirect heat exchange. Regardless of the particular type, this cooler may more specifically perform cooling of a heated scrubber feed to provide the scrubber feed (or cooled scrubber feed) that is input directly the scrubber, in which case both the heated and cooled streams may comprise an un-scrubbed gasifier effluent, such as the filtered gasifier effluent. It can therefore be appreciated that, according to specific embodiments, the “heated scrubber feed” may correspond to, or may comprise, the “filtered gasifier effluent.” Also, the heated scrubber feed/filtered gasifier effluent and the scrubber feed/cooled scrubber feed may be specific examples of an “un-scrubbed gasifier effluent.” In some embodiments, a scrubber feed cooler may be absent, such as in the case of sufficient cooling occurring upstream of the filtration operation for direct use of the filtered gasifier effluent in the scrubbing operation. In such cases, the “scrubber feed” may correspond to, or may comprise, the “filtered gasifier effluent.”

In representative embodiments, the scrubber feed, whether or not having been cooled in a scrubber feed cooler, may have been cooled generally, upstream and/or downstream of the filtration operation, to a temperature from about 200° C. (392° F.) to about 450° C. (842° F.), and preferably from about 225° C. (437° F.) to about 325° C. (617° F.). Such temperature may correspond to the scrubber gas inlet temperature or scrubber operating temperature. In the case of using a scrubber feed cooler downstream of the filtration operation, as illustrated in FIG. 1, the heated scrubber feed, directly upstream of this cooler, may have a temperature within the ranges given above with respect to the filtered gasifier effluent, which may be from about 250° C. (482° F.) to about 600° C. (1112° F.), and preferably from about 275° C. (527° F.) to about 350° C. (662° F.).

### Scrubbing Operation

A scrubbing operation may be used to remove water and water-soluble contaminants from an un-scrubbed gasifier effluent, such as the filtered gasifier effluent exiting the filtration operation, optionally following the cooling of this stream by a scrubber feed cooler. For example, the filtered gasifier effluent may serve as a feed to a boiler that, following indirect heat exchange, provides a cooled effluent upstream of the scrubbing operation, all or at least a portion of which effluent may provide the scrubber feed to the scrubbing operation. Otherwise, in the absence of a scrubber feed cooler, the filtered gasifier effluent, at substantially the temperature exiting the filtration operation, may serve as a feed to the scrubbing operation. In either case, the scrubbing operation itself may provide further cooling of the scrubber feed. For example, the scrubbed gasifier effluent exiting the scrubber may have a temperature from about 35° C. (95° F.) to about 100° C. (212° F.), and preferably from about 43° C. (110° F.) to about 66° C. (150° F.).

The scrubbing operation, such as wet scrubbing, may be effective for removing, as water-soluble contaminants, chlorides (e.g., in the form of HCl), ammonia, and HCN, as well as fine solid particles (e.g., char and ash). For example, in the case of using a wet scrubber, an un-scrubbed gasifier effluent, such as the scrubber feed obtained optionally following cooling, may be fed to a trayed column to perform co-current or counter-current contacting with water or an aqueous solution. Further cooling in this column, such as to a temperature below 100° C. (212° F.) can aid in droplet condensation for improving the contaminant removal effectiveness. The scrubbing operation can be used to provide a scrubbed gasifier effluent exiting, or obtained directly from, this operation and having a combined amount of chloride, ammonia, and solid particles of less than 1 wt-ppm, and possibly less than 0.1 wt-ppm. The scrubbing operation also generally serves to remove water, such that the moisture content of the scrubbed gasifier effluent is reduced, relative to that of the scrubber feed.

According to preferred embodiments as described herein, the scrubbing operation may also provide an aqueous product stream, or ammoniated water product, into which ammonia in the gasifier effluent (e.g., filtered gasifier effluent) is preferentially dissolved and thereby removed from this stream. The scrubbing operation may further provide an aqueous product stream, or first stage purge, into which chlorides in the gasifier effluent (e.g., filtered gasifier effluent) are preferentially dissolved and thereby removed from this stream.

### WGS Operation

The water gas shift (WGS) operation reacts CO present in a gasifier effluent, for example the scrubbed gasifier effluent immediately exiting the scrubbing operation, with steam to increase H₂ concentration (as well as CO₂ concentration). In this manner, the scrubbed gasifier effluent may be characterized as a feed to the WGS operation (WGS feed). Following the tar removal operation, filtration operation, and scrubbing operation, the scrubbed gasifier effluent/feed to the WGS operation may have favorable properties for use in this operation, in terms of its being free or substantially free of water-soluble contaminants as described above, as well as tars and particulates.

According to some embodiments, the scrubbed gasifier effluent/feed to the WGS operation may be heated and/or supplemented with moisture (steam) to further improve its properties for kinetically and/or thermodynamically favoring the WGS reaction that desirably increases the H₂:CO molar ratio and/or H₂ concentration of the WGS product relative these characteristics of the WGS feed. For example, this feed may be heated to a temperature from about 225° C. (437° F.) to about 475° C. (887° F.), and preferably from about 260° C. (500° F.) to about 399° C. (750° F.), prior to its input to the WGS operation. The moisture content of this feed may be augmented utilizing a supplemental source steam, such as at least a portion of the generated steam provided from the steam generation (e.g., using a boiler) as described above. For example, at least a portion of steam (e.g., low or medium pressure steam) generated in the boiler may be fed or added to the WGS operation (e.g., to one or more reactors used in this operation), thereby improving overall heat balancing/integration. In the WGS operation, the use of steam in excess of the stoichiometric amount may be beneficial, particularly in adiabatic, fixed-bed reactors, for a number of purposes. These include driving the equilibrium toward hydrogen production, adding heat capacity to limit the exothermic temperature rise, and minimizing side reactions, such as methanation.

Reactors used in a WGS operation may contain a suitable catalyst, such as those comprising one or more of Co, Ni, Mo, and W on a solid support, particular examples of which are Co/Mo and Ni/Mo catalysts that exhibit sulfur tolerance. Other catalysts for use in this operation (i.e., contained within one or more WGS reactors) include those based on copper-containing and/or zinc-containing catalysts, such as Cu—Zn—Al; chromium-containing catalysts; iron oxides; zinc ferrite; magnetite; chromium oxides; and any combination thereof (e.g., Fe₂O₃—Cr₂O₃ catalysts).

In a typical WGS operation, two or more reactors with interstage cooling are used in view of the thermodynamic characteristics of the WGS reaction. For example, a high-temperature shift (HTS) reactor may operate with a temperature of the reactor inlet from about 310° C. (590° F.) to about 450° C. (842° F.), with more favorable reaction kinetics but a less favorable equilibrium conversion. The effluent from the HTS may then be cooled to a temperature suitable for the reactor inlet of a low-temperature shift (LTS) reactor, such as from about 200° C. (392° F.) to about 250° C. (482° F.), for providing less favorable reaction kinetics but a more favorable equilibrium conversion, such that the combined effect of the HTS and LTS reactors results in a high conversion to H₂ with a favorable residence time. In some cases, it may be desirable to use three or more reactors, or catalyst beds, to perform the WGS reaction, again with cooling between consecutive reactors or catalyst beds.

In this manner, the WGS operation may be used to provide an immediate WGS product exiting, or obtained directly from, this operation and having an increased H₂:CO molar ratio and increased H₂ concentration, relative to the feed to the WGS operation or the synthesis gas obtained from upstream operations (e.g., filtered gasifier effluent or cooled gasifier effluent). For example, the immediate WGS product may have an H₂:CO molar ratio from about 0.5 to about 3.5, from about 1.0 to about 3.0, or from about 1.5 to about 2.5 and/or a hydrogen concentration of at least about 35 mol-% (e.g., from about 35 mol-% to about 80 mol-%), at least about 40 mol-% (e.g., from about 40 mol-% to about 70 mol-%), or at least about 45 mol-% (e.g., from about 45 mol-% to about 65 mol-%). These characteristics of the immediate WGS product may be controlled by bypassing the WGS operation to a greater or lesser extent (e.g., diverting a smaller or larger portion of the feed to this operation, around this operation to provide a portion of the immediate WGS product). The WGS operation may be further beneficial in terms of converting carbonyl sulfide (COS) to H₂S which can be recycled and more easily removed elsewhere in the process, such as in an acid gas removal operation or possibly, at least to some extent, in the scrubbing operation.

### Syngas Conversion or Separation Operations

In some embodiments, processes described herein may also include a syngas conversion operation or syngas separation operation to produce a respective renewable syngas conversion product or renewable syngas separation product, such as liquid hydrocarbons, methanol, or RNG as examples of conversion products, and purified hydrogen as an example of a separation product. In the case of liquid hydrocarbon production, the syngas conversion operation may comprise a Fischer-Tropsch (FT) reaction stage. One or more reactors in this stage are used to process the synthesis gas mixture of hydrogen (H₂) and carbon monoxide (CO) by successive cleavage of C—O bonds and formation of C—C bonds with the incorporation of hydrogen. This mechanism provides for the formation of hydrocarbons, and particularly straight-chain alkanes, with a distribution of molecular weights that can be controlled to some extent by varying the FT reaction conditions and catalyst properties. Such properties include pore size and other characteristics of the support material. The choice of FT catalyst and its active metals (e.g., Fe or Ru) can impact FT product yields in other respects, such as in the production of oxygenates.

In the case of methanol production, the syngas conversion operation may comprise a methanol synthesis reaction stage. One or more reactors in this stage are used to form methanol according to the catalytic reaction:

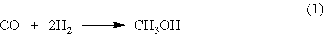

Representative catalysts for the synthesis of methanol by this route are characterized by “CZA,” which is a reference to copper and zinc on alumina, or Cu/ZnO/Al₂O₃. Alternatively, or in combination, various other catalytic metals and their oxides may be used, including one or more of W, Zr, In, Pd, Ti, Co, Ga, Ni, Ce, Au, Mn, and their combinations.

In the case of methane production as a syngas conversion operation to provide a renewable natural gas (RNG) product, one or more methanation reactors (e.g., in series or parallel) may be used to react CO and/or CO₂ with hydrogen and thereby provide a hot methanation product having a significantly higher concentration of methane relative to that initially present (e.g., in the WGS product). Catalysts suitable for use in a methanation reactor include supported metals such as ruthenium and/or other noble metals, as well as molybdenum and tungsten. Generally, however, supported nickel catalysts are most cost effective. Often, a methanation reactor is operated using a fixed bed of the catalyst.

In the case of purified hydrogen production, the syngas separation operation may comprise a renewable hydrogen separation stage that can utilize, for example, (i) an adsorbent in the case of separation by PSA or (ii) a membrane. Combinations of such stages may be used in a given syngas separation operation. In any such operation, a gaseous separation byproduct is also provided that is generally enriched in the non-hydrogen components of syngas, such as CO, CO₂, and/or H₂O. This byproduct may be, for example, a PSA tail gas or otherwise a membrane permeate or retentate, depending on the particular membrane used and consequently whether the renewable hydrogen separation product is recovered as the membrane retentate or permeate. This hydrogen, obtained as a result of utilizing a syngas separation operation downstream of the WGS operation, may, in some embodiments, be characterized as high purity hydrogen (e.g., having a purity of at least about 99 mol-% or more, such as at least 99.9 mol-% or at least 99.99 mol-%).

### Further Exemplary Embodiments of Gasification Processes

FIG. 1 depicts a flowscheme illustrating an embodiment of a process including operations as described above, and further utilizing a scrubber operation for generating an ammoniated water product. With reference to FIG. 1, and with the understanding that embodiments disclosed herein do not necessarily require all of the illustrated features, such embodiments may be directed to a process for gasification of a carbonaceous feed (e.g., wood) generally. The process may comprise, in gasifier 50, contacting carbonaceous feed 10 (which may be a dried carbonaceous feed, following drying) with oxygen-containing gasifier feed 14 (and optionally a separate source of steam) under gasification conditions to provide an un-scrubbed gasifier effluent comprising H₂, CO, and water-soluble contaminants. Oxygen-containing gasifier feed 14 alone (or possibly in combination with a separate source of steam), may comprise H₂O and O₂, as well as optionally CO₂, in a combined concentration of at least about 90 mol-%, at least about 95 mol-%, or at least about 99 mol-%. The un-scrubbed gasifier effluent may be any process stream downstream of gasifier 50 and upstream of scrubbing operation 80, including raw gasifier effluent 16, tar-depleted gasifier effluent 18, quenched gasifier effluent 22, cooled gasifier effluent 24, filtered gasifier effluent 26, or scrubber feed 28.

The process may further comprise feeding at least a portion of the un-scrubbed gasifier effluent, for example as scrubber feed 28, to scrubbing operation 80 to remove at least a portion of the water-soluble contaminants and provide scrubbed gasifier effluent 30. In the absence of scrubber feed cooler 75, the scrubber feed may correspond to, or may comprise, filtered gasifier effluent 26, which may be fed directly to scrubbing operation 80. In the case utilizing scrubber feed cooler 75, an un-scrubbed gasifier effluent or portion thereof may be fed, for example as filtered gasifier effluent/heated scrubber feed 26, to cooler 75. In some embodiments, cooler 75 may provide steam generation from heat in this heated scrubber feed, as well as provide scrubber feed 28 (which may also be referred to as a cooled scrubber feed in such embodiments). It can therefore be appreciated that either or both of heated scrubber feed 26 and scrubber feed 28 may correspond to, or may comprise, an un-scrubbed gasifier effluent, such as in the particular case of an un-scrubbed gasifier effluent, that, as a heated scrubber feed, is at a higher temperature relative to this un-scrubbed gasifier effluent, as a scrubber feed. The un-scrubbed gasifier effluent, as heated scrubber feed 26 and scrubber feed 28, may have the same composition.

In exemplary embodiments, the un-scrubbed gasifier effluent, which is optionally fed to cooler 75 as heated scrubber feed 26 or directly fed to scrubbing operation 80 as scrubbed feed 28, may be a filtered gasifier effluent, having been subjected to filtration operation 70, as an intervening operation, to remove solid particles. More particularly, in addition to having been subjected to filtration operation 70, the filtered gasifier effluent may have been further subjected to one or more other intervening operations downstream of gasifier 50 and upstream of filtration operation 70. For example, such intervening operations may include one or more of (i) tar removal operation 55 to remove at least a portion of gasifier effluent tar (e.g., and provide tar-depleted gasifier effluent 18), (ii) quenching operation 60 comprising direct contact with quench water 20 (e.g., and provide quenched gasifier effluent 22), and (iii) radiant syngas cooler 65 (RSC) or convective syngas cooler (CSC) 65, implementing heat-exchanging contact with, respectively, RSC feed water or CSC feed water (e.g., and provide cooled gasifier effluent 24). Optionally in combination with any of these particular intervening operations, other intervening operations may include both filtration operation 70 and scrubber feed cooler 75 downstream of this operation. In this case, the un-scrubbed gasifier effluent, at least a portion of which is fed as a scrubber feed to scrubbing operation 80, according to any exemplary process as described herein, may be more particularly a filtered and cooled gasifier effluent, having been subjected to filtration operation 70 to remove solid particles and also to scrubber feed cooler 75.

In achieving various benefits and advantages as described herein, a representative process may comprise recovering from scrubbing operation 80, following at least a first scrubber contacting stage, ammoniated water product 34. Otherwise, a representative process may comprise recovering from scrubbing operation 80 in this manner, both ammoniated water product 34 and a chloride-enriched aqueous product. This latter product may typically be an aqueous product of the first scrubber contacting stage, operating under conditions suitable for preferential dissolution of chlorides relative to ammonia, and providing a first stage overhead product vapor (either internal to, or external to, a scrubber vessel) substantially depleted in chlorides and other water-soluble contaminants other than ammonia. Conditions suitable for preferential dissolution of chlorides relative to ammonia may include a higher temperature of the first scrubber contacting stage, relative to an internal, second scrubber contacting stage or higher scrubber contacting stage, or otherwise relative to an external vapor-liquid separator.

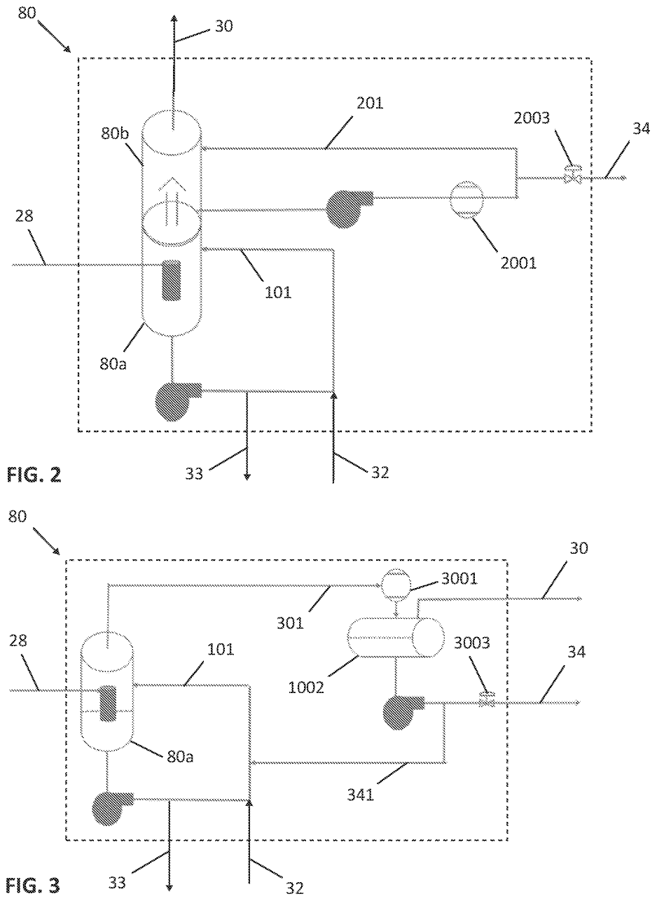

In this regard, FIGS. 2 and 3 illustrate additional details with respect to the flows of various aqueous feed and product streams to and from scrubbing operation 80, the boundaries of which are shown by dashed lines. According to the embodiment illustrated in FIG. 2, the “at least a first scrubber contacting stage” comprises both first scrubber contacting stage (or first stage scrubber) 80a and second scrubber contacting stage (or second stage scrubber) 80b. Second scrubber contacting stage 80b further contacts and purifies a first stage overhead product of first scrubber contacting stage 80a, which may pass upwardly in a vessel in which both scrubber contacting stages 80a, 80b are disposed (e.g., in vertical alignment). First and second scrubber contacting stages 80a, 80b may be demarcated at least partially (e.g., according to their upper boundaries) by axial heights at which respective, separate first stage aqueous scrubber feed 101 and second stage aqueous scrubber feed 201 are input to such vessel.

In the embodiment illustrated in FIG. 2, ammoniated water product 34 is recovered as, or comprises, a portion of second stage aqueous scrubber feed 201, optionally following cooling by second stage aqueous recycle loop cooler 2001. Second stage aqueous scrubber feed 201 is input to second scrubber contacting stage 80b. The drawoff or “blowdown” of ammoniated water product 34 may be governed by recycled ammoniated water product (AWP) level or flow control valve 2003 used to regulate the operation of second scrubber contacting stage 80b, for example in terms of the liquid level in the bottom of this stage (e.g., present on a perforated tray). In this embodiment, ammoniated water product 34 may be withdrawn from a second stage aqueous recycle loop comprising second stage aqueous scrubber feed 201, with the temperature in this second stage aqueous recycle loop being governed by the particular operation of a scrubber vessel in which first and second scrubber contacting stages 80a, 80b are disposed. This temperature may also be regulated to some extent using second stage aqueous recycle loop cooler 2001, which may be in any suitable form, such as a cooling tower or air fan cooler. In exemplary embodiments, liquid temperatures in the second stage aqueous recycle loop, directly upstream of second stage aqueous recycle loop cooler 2001, may be in the range from about 52° C. (125° F.) to about 177° C. (350° F.), such as from about 66° C. (150° F.) to about 149° C. (300° F.). Directly downstream of second stage aqueous recycle loop cooler 2001, liquid temperatures may be in the range from about 24° C. (75° F.) to about 49° C. (120° F.), such as from about 32° C. (90° F.) to about 43° C. (110° F.).

Those skilled in the art and having knowledge of the present disclosure will appreciate that, according to further, analogous embodiments, the ammoniated water product may be recovered as a portion of a higher scrubber contacting stage (e.g., third scrubber contacting stage, fourth scrubber contacting stage, etc.), which may likewise be demarcated by an axial height of input of a respective aqueous scrubber feed. It will also be appreciated that, according to the embodiment illustrated in FIG. 3, first stage overhead vapor-liquid separator 1002 effectively performs a second scrubber contacting stage that is external to the scrubber vessel in which first scrubber contacting stage 80a is disposed. In this embodiment, following a first scrubber contacting stage 80a, which may be the only scrubber contacting stage occurring internal to a scrubber vessel, ammoniated water product 34 is recovered as a liquid phase of vapor-liquid separator, which in this embodiment is namely first stage overhead vapor-liquid separator 1002. This vapor-liquid separator 1002 may effectively perform, ideally, one theoretical vapor-liquid equilibrium contacting plate. More generally, however, first scrubber contacting stage 80a and second scrubber contacting stage 80b, as illustrated in FIG. 2, as well as any higher scrubber contacting stage(s), may perform one or multiple theoretical vapor-liquid equilibrium contacting plates.

FIGS. 2 and 3 therefore illustrate embodiments in which ammoniated water product 34 is condensed from the first stage overhead vapor product exiting the first scrubber contacting stage. According to the embodiment illustrated in FIG. 3 (and unlike the embodiment illustrated in FIG. 3), first stage overhead vapor product 301 exits externally to the scrubber vessel in which first scrubber contacting stage 80a is disposed, and the scrubber vessel in such embodiment does not contain a second scrubber contacting stage. As more particularly illustrated in FIG. 3, first stage overhead product 301 is cooled by first stage overhead condenser 3001 to condense liquid, prior to separation of this liquid from scrubbed gasifier effluent 30 and recovery of ammoniated water product 34 from at least a portion of this separated liquid. According to this embodiment, ammoniated water product 34 may be recovered as a net product, the drawoff or “blowdown” of which may be governed by condensed ammoniated water product (AWP) level or flow control valve 3003 used to regulate the operation of condensed liquid product recovery and removal, for example in terms of the liquid level in first stage overhead condenser 3001. First stage overhead condenser 3001 may be in any suitable form, such as a cooling tower or air fan cooler, and may be used to regulate, at least to some extent, temperatures first stage overhead product vapor 301, scrubbed gasifier effluent 30, and/or ammoniated water product 34. In exemplary embodiments, the temperature of first stage overhead product vapor 301, upstream of this condenser, may be in the range from about 52° C. (125° F.) to about 177° C. (350° F.), such as from about 66° C. (150° F.) to about 149° C. (300° F.). Temperatures of scrubbed gasifier effluent 30 and ammoniated water product 34, downstream of this condenser and following separation in first stage overhead vapor-liquid separator, may be in the range from about 24° C. (75° F.) to about 49° C. (120° F.), such as from about 32° C. (90° F.) to about 43° C. (110° F.), or may be in other preferred ranges of temperature of the scrubbed gasifier effluent as described above.

FIGS. 2 and 3 illustrate particular embodiments for performing scrubbing operation 80 (e.g., according to the process illustrated in FIG. 1), with the flows of scrubber feed 28 and makeup scrubber water 32, also shown in FIG. 1, entering the boundaries of this operation and the flows of scrubbed gasifier effluent 30 and ammoniated water product 34, also shown in FIG. 1, exiting the boundaries of this operation. The boundaries of scrubbing operation 80 in FIGS. 2 and 3 are shown by dashed lines. As further illustrated in these figures, representative processes may also comprise withdrawing first stage purge 33 that is enriched in chlorides and thereby serves to remove a predominant amount of these contaminants that are present in, and that enter scrubbing operation 80 with, scrubber feed 28. More particularly, first stage purge 33 may be enriched in chlorides, for example may have a greater concentration of total chloride, relative to scrubber feed 28. All or a portion of this total chloride may be in the form of HCl and, accordingly, first stage purge, which may contain all or substantially all chloride present in the scrubber feed, is generally acidic. Representative processes may therefore comprise withdrawing, from a first stage aqueous recycle loop comprising the first stage aqueous scrubber feed that is input to the first scrubber contacting stage, the first stage purge. As illustrated in FIGS. 2 and 3, makeup scrubber water 32 may be added to the first stage aqueous recycle loop. According to various embodiments, including those specifically illustrated in FIGS. 2 and 3, at least a portion of the ammoniated water product may be recycled to the first scrubber contacting stage, such as added to the first stage scrubber feed that is input to the first scrubber contacting stage (e.g., added to the first stage aqueous recycle loop comprising the first stage aqueous scrubber feed.) For example, FIG. 3 illustrates optional recycle portion 341 of ammoniated water product 34 that is recycled to first scrubber contacting stage 80a, by being added to first stage scrubber feed 101 or to the first stage aqueous recycle loop comprising this feed.

The ammoniated water product is generally basic, and, in view of its having been subjected to at least a first scrubber contacting stage, also a “clean” product from which various acidic contaminants such as chlorides have been removed. The ammoniated water product comprises ammonia derived from nitrogen present in the carbonaceous feed (e.g., wood), and therefore the ammonia concentration and pH of this product may depend at least to some extent on the nitrogen content of this feed. Such nitrogen content may vary considerably, for example this may be in the range from about 0.1 wt-% to about 1.5 wt-%, or from about 0.3 wt-% to about 1 wt-%. In representative embodiments, the ammoniated water product may have a pH of at least about 7.5 (e.g., in the range from about 7.5 to about 11, such as from about 7.5 to about 8.5). In view of its alkalinity and overall quality (e.g., purity), the ammoniated water product may advantageously be utilized directly in the process, such as added directly to a stream or operation of the process to satisfy process requirements, and particularly those requirements that would otherwise require external resources/utilities, such as high-quality makeup water (e.g., boiler feed water). For example, the ammoniated water product may be added to one or more intervening operations described herein, such as in the case of at least a portion of this product being added to a quenching operation to provide all or at least a portion of the quench water needed for this operation. In these and other embodiments of utilizing at least a portion of the ammoniated water product directly in the process, this product may be used more particularly for neutralization (e.g., reaction with chlorides in the form of HCl to reduce or eliminate acidity), in view of its alkalinity.

With respect to utilizing the ammoniated water product in the process, particular embodiments of interest include adding at least a portion of this product to a sump of the process, a slag water system of the process, and/or a cooler of the process. For example, as illustrated in FIG. 1, representative processes may comprise adding all or a portion of ammoniated water product 34 for one or more of these applications. According to representative processes, (i) at least a portion, such as first portion 34a, of ammoniated water product 34 may be added to radiant syngas cooler (RSC) sump 65a or RSC slag water system 65b (e.g., such as in the case of RSC slag water system 65b interfacing RSC sump 65a) or otherwise to convective syngas cooler (CSC) sump 65a or CSC slag water system 65b (e.g., such as in the case of CSC slag water system 65b interfacing CSC sump 65a), (ii) at least a portion, such as second portion 34b, of ammoniated water product 34 may be added to quenching operation sump 60a or quenching operation slag water system 60b (e.g., such as in the case of quenching operation slag water system 60b interfacing quenching operation sump 60a); and/or at least a portion, such as third portion 34c, of ammoniated water product 34 may be added to quenching operation 60, for example to provide all or at least a portion of quench water 20 that is fed to quenching operation 60.

With respect to various features of representative processes, raw gasifier effluent 16 produced in gasifier 50 is fed to tar removal operation 55, to provide tar-depleted gasifier effluent 18, having a lower amount of tar relative to raw gasifier effluent 16. Generally, processes comprise recovering a synthesis gas product from tar-depleted gasifier effluent 16, with such synthesis gas product possibly including any of those downstream of tar-depleted gasifier effluent 16 as illustrated in the FIG. 1. For example, the synthesis gas product may be recovered as water-gas shift (WGS) product 36 of WGS operation 90, optionally following one or more intervening operations performed on the gasifier effluent, downstream of the tar removal operation and upstream of the WGS operation. Such intervening operations can include one or more of (i) quenching operation 60 comprising direct contact of the gasifier effluent with quench water 20, (ii) radiant syngas cooler (RSC) 65 or convective syngas cooler (CSC) 65, implementing heat-exchanging contact of the gasifier effluent with RSC feed water or CSC feed water, as the case may be (iii) filtration operation 70 to remove solid particles from the gasifier effluent, (iv) scrubber feed cooler 75 to further remove heat from the gasifier effluent and control the temperature of the downstream scrubbing operation as described herein, and (v) scrubbing operation 80 to remove water-soluble contaminants from the gasifier effluent.

As more particularly illustrated in the FIG. 1, a representative process comprises, in quenching operation 60, which may be more particularly a partial dry quench (PDQ) operation, contacting (e.g., by direct contact), tar-depleted gasifier effluent 18 with quench water 20, which may comprise at least a portion 34c of ammoniated water product 34. The quenching operation provides quenched gasifier effluent 22, having a temperature that is decreased relative to that of tar-depleted gasifier effluent 18. The process may additionally comprise, in radiant syngas cooler (RSC) 65 or convective syngas cooler (CSC) 65, further cooling quenched gasifier effluent 22, such as by indirect, heat-exchanging contact with RSC feed water or CSC feed water, respectively. This provides cooled gasifier effluent 24, which may then be subjected to filtration operation 70, heat removal in scrubber feed cooler 75, and scrubbing operation 80, with particular details of these operations as described herein, and as optionally illustrated in FIGS. 2 and 3 with respect to scrubbing operation 80. Feeding at least a portion of scrubbed gasifier effluent 30, provided from scrubbing operation 80, to WGS operation 90, provides WGS product 36 having a H₂:CO molar ratio that is increased relative to that of raw gasifier effluent 16, and/or syngas exiting any of intervening operations, such as tar-depleted gasifier effluent 18, quenched gasifier effluent 22, cooled gasifier effluent 24, filtered gasifier effluent 26 exiting filtration operation 70, scrubber feed 28 to scrubbing operation 80, or scrubbed gasifier effluent 30 exiting scrubbing operation 80.

Representative processes may further comprise feeding at least a portion of WGS product 36 to syngas conversion operation 95 or syngas separation operation 95 to provide respective renewable syngas conversion product 40 or renewable syngas separation product 40. According to more specific embodiments, for example, (i) syngas conversion operation 95 may comprise a Fischer-Tropsch reaction stage, such that renewable syngas conversion product 40 comprises liquid hydrocarbons and/or oxygenates (e.g., alcohols) of varying carbon numbers, (ii) syngas conversion operation 95 may comprise a catalytic methanol synthesis reaction stage, such that renewable syngas conversion product 40 comprises methanol, or (iii) syngas conversion operation 95 may comprise a catalytic methanation reaction stage, such that renewable syngas conversion product 40 comprises RNG. According to other more specific embodiments, syngas separation operation 95 may comprise a renewable hydrogen separation stage, such that renewable syngas separation product 40 comprises purified hydrogen.

Overall, aspects of the invention relate to gasification processes implementing a scrubbing operation in which, following at least a first scrubber contacting stage, an ammoniated water product is recovered, such as by condensation from an overhead vapor product of the first contacting stage. The overhead vapor product may be internal or external to a scrubber vessel in which the first scrubber contacting stage is disposed, for example this product may be external to a scrubber vessel in which only a first scrubber contacting stage is disposed, or it may be internal to a scrubber vessel in which both the first scrubber contacting stage and a second scrubber contacting stage are disposed, with each contacting stage being fed by respective aqueous scrubber feeds. This ammoniated water product, due to its overall quality and alkalinity, may advantageously be utilized to satisfy requirements of operations within the process, and particularly those that may be benefit from neutralization. Those skilled in the art, having knowledge of the present disclosure, will recognize that various changes can be made to these processes in attaining these and other advantages, without departing from the scope of the present disclosure. As such, it should be understood that the features of the disclosure are susceptible to modifications and/or substitutions, and the specific embodiments described herein are for illustrative purposes only, and not limiting of the invention as set forth in the appended claims.

1. A process for gasification of a carbonaceous feed, the process comprising:
in a gasifier, contacting the carbonaceous feed with an oxygen-containing gasifier feed, under gasification conditions, to provide an un-scrubbed gasifier effluent comprising H₂, CO, and water-soluble contaminants;
feeding at least a portion of the un-scrubbed gasifier effluent, as a scrubber feed, to a scrubbing operation to remove at least a portion of the water-soluble contaminants, and provide a scrubbed gasifier effluent;
recovering from the scrubbing operation, following at least a first scrubber contacting stage, an ammoniated water product.

2. The process of claim 1, wherein:
said at least first scrubber contacting stage comprises both the first scrubber contacting stage and a second scrubber contacting stage, and
said ammoniated water product is recovered as a portion of a second stage aqueous scrubber feed that is input to said second scrubber contacting stage.

3. The process of claim 1, wherein said ammoniated water product is recovered as a liquid phase of a vapor-liquid separator, for separating a first stage overhead vapor product of said first scrubber contacting stage.

4. The process of claim 1, wherein said at least first scrubber contacting stage performs one or more theoretical vapor-liquid equilibrium contacting plates.

5. The process of claim 1, wherein at least a portion of said ammoniated water product is added to a first stage aqueous scrubber feed that is input to said first scrubber contacting stage.

6. The process of claim 1, further comprising withdrawing, from a first stage aqueous recycle loop comprising a first stage aqueous scrubber feed that is input to said first scrubber contacting stage, a first stage purge that is enriched in chlorides.

7. The process of claim 1, wherein the ammoniated water product has a pH of at least about 7.5.

8. The process of claim 1, wherein at least a portion of the ammoniated water product is utilized directly in the process.

9. The process of claim 8, wherein said at least portion of the ammoniated water product is utilized for neutralization.

10. The process of claim 8, wherein said at least portion of the ammoniated water product is added to a sump of the process, a slag water system of the process, and/or a cooler of the process.

11. The process of claim 8, wherein:
at least a first portion of the ammoniated water product is added to a radiant syngas cooler (RSC) sump, an RSC slag water system, a convective syngas cooler (CSC) sump, or a CSC slag water system,
at least a second portion of the ammoniated water product is added to a quenching operation sump or a quenching operation slag water system; and/or
at least a third portion of the ammoniated water product is added to a quenching operation.

12. The process of claim 1, further comprising feeding at least a portion of the scrubbed gasifier effluent to a water-gas shift (WGS) operation, to provide a WGS product having an H₂:CO molar ratio that is increased, relative to that of the scrubbed gasifier effluent.

13. A process for gasification of a carbonaceous feed, the process comprising:
in a gasifier, contacting the carbonaceous feed with an oxygen-containing gasifier feed, under gasification conditions, to provide an un-scrubbed gasifier effluent comprising H₂, CO, and water-soluble contaminants;
optionally following one more intervening operations downstream of the gasifier, feeding at least a portion of the un-scrubbed gasifier effluent, as a scrubber feed, to a scrubbing operation to remove at least a portion of the water-soluble contaminants, and provide a scrubbed gasifier effluent;
recovering from the scrubbing operation, an ammoniated water product and a chloride-enriched aqueous product.

14. The process of claim 13, wherein said ammoniated water product comprises ammonia derived from nitrogen present in said carbonaceous feed.

15. The process of claim 13, wherein the ammoniated water product is added to said one or more intervening operations.

16. The process of claim 13, wherein:
said one or more intervening operations includes a filtration operation, and
said un-scrubbed gasifier effluent is a filtered gasifier effluent, having been subjected to said filtration operation to remove solid particles.

17. The process of claim 16, wherein:
said one or more intervening operations includes said filtration operation and further includes a scrubber feed cooler, downstream of said filtration operation, and
said un-scrubbed gasifier effluent is a filtered and cooled gasifier effluent, having been subjected to said filtration operation to remove solid particles and said scrubber feed cooler.

18. The process of claim 16, wherein the filtered gasifier effluent, in addition to having been subjected to said filtration operation, has been subjected to one or more further intervening operations, downstream of the gasifier and upstream of said filtration operation, said one or more further intervening operations selected from the group consisting of (i) a tar removal operation to remove at least a portion of gasifier effluent tar, (ii) a quenching operation comprising direct contact with quench water, and (iii) a radiant syngas cooler (RSC) or a convective syngas cooler (CSC), implementing heat-exchanging contact with RSC feed water or CSC feed water.

19. The process of claim 13, further comprising:
feeding at least a portion of the scrubbed gasifier effluent to a water-gas shift (WGS) operation, to provide a WGS product having a H₂:CO molar ratio that is increased, relative to that of the scrubbed gasifier effluent.

20. The process of claim 19, further comprising:
feeding at least a portion of the WGS product to (i) a syngas conversion operation to provide a renewable syngas conversion product, or (ii) a syngas separation operation to provide a renewable syngas separation product.
